(19) United States
(12) Patent Application Publication
(10) Pub. No.: US 2016/0263757 A1
(43) Pub. Date: Sep. 15, 2016

(54) Razor Assembly

(71) Applicants: Terra Vandervelde, Millet (CA); Amy Durocher, Milet (CA)

(72) Inventors: Terra Vandervelde, Millet (CA); Amy Durocher, Milet (CA)

(21) Appl. No.: 14/657,368

(22) Filed: Mar. 13, 2015

(51) Int. Cl. B26B 21/52; B26B 21/40

(52) U.S. Cl. CPC B26B 21/521; B26B 21/4012

(57) ABSTRACT

A razor assembly includes a razor that has a handle portion and a head portion. The head portion is configured to be utilized for shaving. A positioning apparatus is movably coupled to the handle portion. The positioning apparatus has the head portion coupled thereto such that the head portion is rotatably coupled to the handle portion.

### BACKGROUND OF THE DISCLOSURE

### Field of the Disclosure

The disclosure relates to razor devices and more particularly pertains to a new razor device having a rotatably adjustable head.

### SUMMARY OF THE DISCLOSURE

An embodiment of the disclosure meets the needs presented above by generally comprising a razor that has a handle portion and a head portion. The head portion is configured to be utilized for shaving. A positioning apparatus is movably coupled to the handle portion. The positioning apparatus has the head portion coupled thereto such that the head portion is rotatably coupled to the handle portion.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a razor assembly according to an embodiment of the disclosure.

FIG. 2 is a back view of an embodiment of the disclosure.

FIG. 3 is a cross sectional view taken along line 3-3 of FIG. 1 of an embodiment of the disclosure.

FIG. 4 is a right side view of an embodiment of the disclosure.

FIG. 5 is a top view of an embodiment of the disclosure.

### DESCRIPTION OF THE PREFERRED EMBODIMENT

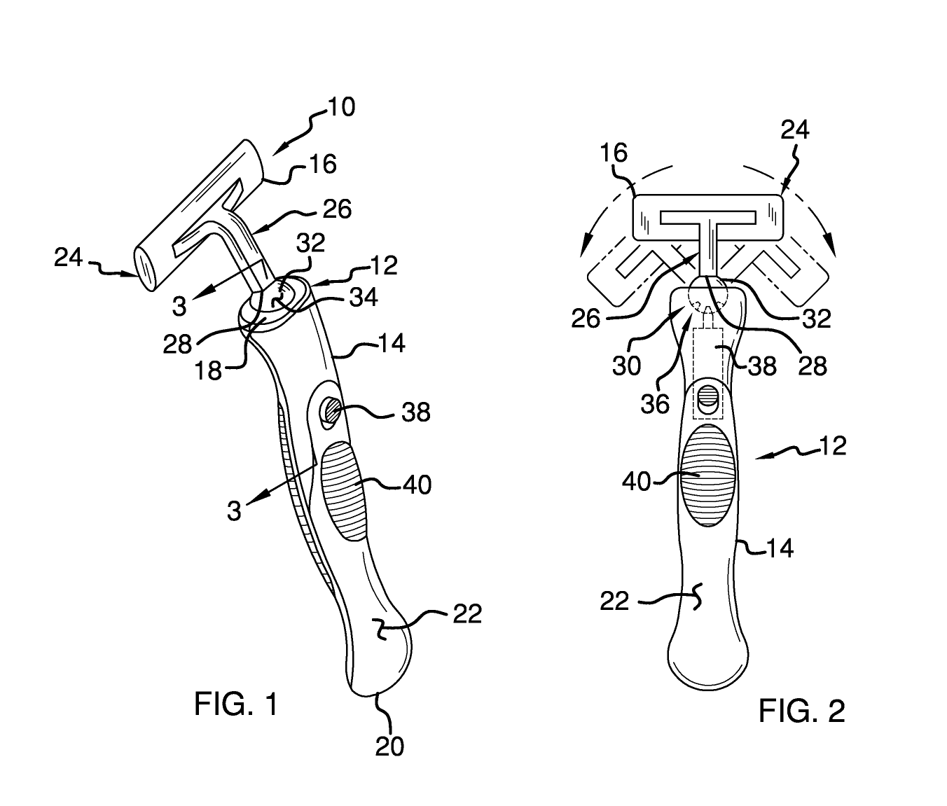

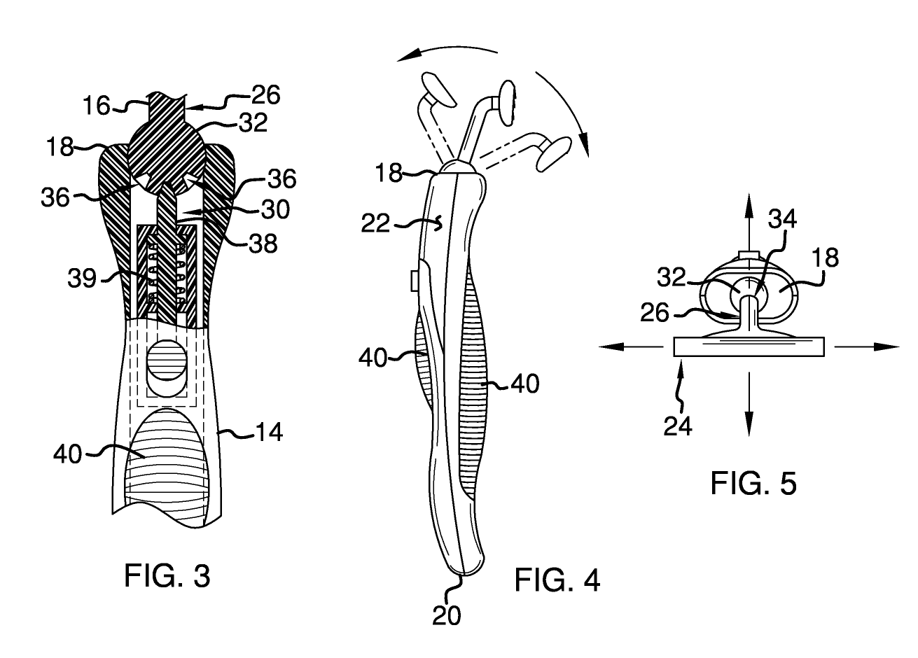

With reference now to the drawings, and in particular to FIGS. 1 through 5 thereof, a new razor device embodying the principles and concepts of an embodiment of the disclosure and generally designated by the reference numeral 10 will be described.

As best illustrated in FIGS. 1 through 5, the razor assembly 10 generally comprises a razor 12 that has a handle portion 14 and a head portion 16. The handle portion 14 has a first end 18, a second end 20 and a peripheral surface 22 extending therebetween. The head portion 14 has a cutting section 24 and a stem section 26 coupled thereto and the stem section 26 has a distal end 28 with respect to the cutting section 24. The stem section 26 is oriented transverse to the cutting section 24 and the distal end 28 is movably coupled to the first end 18. The cutting section 24 may comprise a disposable razor or the like and the cutting section 24 is removable from the stem section 26.

A positioning apparatus 30 is movably coupled to the handle portion 14. The positioning apparatus 30 has the head portion 16 coupled thereto such that the head portion 16 is rotatably coupled to the handle portion 14. The positioning apparatus 30 comprises a ball 32 positioned within the first end 18 and the ball 32 rotates freely in the first end 18. The ball 32 has an outer surface 34 and the outer surface 34 has a plurality of slots 36 extending inwardly therein. The slots 36 are spaced apart from each other along the outer surface 34. The ball 32 is oriented in the first end 18 such that the slots 36 are concealed within the handle portion 14. The ball 32 has the distal end 28 coupled thereto such that the head portion 16 is rotatable about an axis extending through the first end 18 and the second end 20.

A stop 38 is positioned within the handle portion 14. The stop 38 is slidable into a locking position so the stop 38 engages one of the slots 36 to retain the head portion 16 at a selected position with respect to the handle portion 14. The stop 38 is slidable into a releasing position so the stop 38 is spaced from the ball 32 to allow the ball 32 to rotate freely. A spring biasing member 39 biases the stop into the locking position. The stop 38 extends outwardly from the peripheral surface 22 to be engaged.

A grip 40 is coupled to the peripheral surface 22 and the grip 40 extends substantially between the first end 18 and the second end 20. The grip 40 may be one of a pair of grips 40 positioned on opposing sides of the handle portion 14.

In use, the stop 38 is slid into the releasing position and the head portion 16 is positioned at the selected position. The stop 38 is slid into the locking position. The razor 12 is utilized in the convention of shaving. The position of the head portion 16 is adjustable while the razor 12 is being used to shave. The cutting section 24 is replaced after the cutting section 24 becomes dull.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A razor assembly having a rotatably positionable head, said assembly comprising
a razor having a handle portion and a head portion, said head portion being configured to be utilized for shaving; and
a positioning apparatus movably coupled to said handle portion, said positioning apparatus having said head portion coupled thereto such that said head portion being rotatably coupled to said handle portion;

2. Said assembly according to claim 1, wherein said handle portion having a first end, a second end and a peripheral surface extending therebetween, said head portion having a cutting section and a stem section coupled thereto.

3. Said assembly according to claim 2, wherein said stem section having a distal end with respect to said cutting section, said stem section being oriented transverse to said cutting section, said distal end being movably coupled to said first end.

4. Said assembly according to claim 2, wherein said positioning apparatus comprises a ball positioned within said first end, said ball rotating freely in said first end, said ball having a an outer surface, said outer surface having a plurality of slots extending inwardly therein, said slots being spaced apart from each other along said outer surface, said ball being oriented in said first end such that said slots are concealed within said handle portion.

5. Said assembly according to claim 4, wherein said ball has said distal end coupled thereto such that said head portion being rotatable about an axis extending through said first end and said second end.

6. Said assembly according to claim 5, further comprising a stop positioned within said handle portion, said stop being slidable into a locking position having said stop engaging one of said slots to retain said head portion at a selected position with respect to said handle portion, said stop being slidable into a releasing position having said stop being spaced from said ball to allow said ball to rotate freely,

7. Said assembly according to claim 2, further comprising a grip coupled to said peripheral surface.

8; A razor assembly having a rotatably positionable head, said assembly comprising:
a razor having a handle portion and a head portion, said handle portion having a first end, a second end and a peripheral surface extending therebetween; said head portion having a cutting section and a stem section coupled thereto, said stem section having a distal end with respect to said cutting section, said stem section being oriented transverse to said cutting section; said distal end being movably coupled to said first end;
a positioning apparatus movably coupled to said handle portion, said positioning apparatus having said head portion coupled thereto such that said head portion being rotatably coupled to said handle portion, said positioning apparatus comprising:
a ball positioned within said first end, said ball rotating freely in said first end, said ball having a an outer surface, said outer surface having a plurality of slots extending inwardly therein, said slots being spaced apart from each other along said outer surface, said ball being oriented in said first end such that said slots are concealed within said handle portion, said ball having said distal end coupled thereto such that said head portion being rotatable about an axis extending through said first end and said second end; and
a stop positioned within said handle portion, said stop being slidable into a locking position having said stop engaging one of said slots to retain said head portion at a selected position with respect to said handle portion, said stop being slidable into a releasing position having said stop being spaced from said ball to allow said ball to rotate freely; and
a grip coupled to said peripheral surface.
